(19) United States
(12) Patent Application Publication
(10) Pub. No.: US 2019/0000111 A1
(43) Pub. Date: Jan. 3, 2019

(54) DEVICE, SYSTEM AND METHOD FOR DISPENSING A FOOD COMPOSITION

(71) Applicant: Conopco, Inc., d/b/a UNILEVER, Englewood Cliffs, NJ (US)

(72) Inventors: William John CRAMER, Comberton (GB); Gary Stephen HOWARD, Swavesey (GB); Paul SCOTT, Histon (GB); Andrew Julian STOCKDALE, Haslingfield (GB); Adrian Michael WOODWARD, Bury St Edmonds (GB)

(73) Assignee: Conopco, Inc., d/b/a UNILEVER, Englewood Cliffs, NJ (US)

(21) Appl. No.: 16/067,843

(22) PCT Filed: Dec. 9, 2016
(86) PCT No.: PCT/EP2016/080431

§ 371 Date: Jul. 3, 2018

(30) Foreign Application Priority Data
Jan. 8, 2016 (EP) 16150656.3

(51) Int. Cl. A23G 9/28

(52) U.S. Cl. CPC A23G 9/281

(57) ABSTRACT

Disclosed is a device (1, 100) for dispensing a food composition (13) from a receptacle (8, 108) comprising a compressed gas inlet (9, 109), the device comprising: a compressed gas source (12); a gas conduit (11) extending from the compressed gas source to a compressed gas outlet (10, 110); a housing (2, 102) surrounding the receptacle and having a door (3, 103) allowing access to the receptacle; and a mechanism (16, 17, 18, 19, 115, 118) for adjusting the relative position of the receptacle and compressed gas outlet in response to movement of the door to urge the compressed gas outlet (10, 110) and the compressed gas inlet (9, 109) into sealing engagement as the door is closed.

### FIELD OF THE INVENTION

The present invention relates to devices, methods and systems for dispensing food compositions. In particular, the invention relates to such methods, systems and devices that dispense frozen confections from receptacles through application of compressed gas.

### BACKGROUND OF THE INVENTION

In recent years, systems for dispensing frozen confections such as soft ice cream have been developed in which pre-packaged ice cream is delivered from a container by a dispensing device. In particular systems which employ bag-in-bottle type containers have been developed.

WO 2013/124193 A discloses a method for dispensing a frozen confection comprising: providing a refrigerated, insulated chamber, which houses at least one container, containing a frozen confection at a temperature of −12° C. or below; wherein the at least one container has an outlet which is closed by a self-closing valve; wherein the container comprises a flexible bag containing the frozen confection located inside a bottle; pressurising gas in the region inside the bottle and outside the flexible bag thereby applying pressure to the frozen confection so that the valve opens and the frozen confection is forced out of the container through the outlet; releasing the pressure so that the valve closes.

The containers used in such systems are usually replaceable and often disposable. As such, a user is required to connect a pressurized gas source to each new container. Where such systems are used out-of-home in retail establishments and the like, they may be used by trained operatives with controlled and regulated procedures being employed.

The present inventors have now recognized that there is a need for improvements in systems for dispensing food compositions like soft ice using pressurized gas. In particular the present inventors have found that improving the way in which a receptacle is connected to a compressed gas source can increase the convenience and/or safety of such systems making them suitable for non-trained operatives, for example, in a domestic in-home setting.

### SUMMARY OF THE INVENTION

In a first aspect, the present invention is directed to a device for dispensing a food composition from a receptacle comprising a compressed gas inlet, the device comprising:
a compressed gas source;
a gas conduit extending from the compressed gas source to a compressed gas outlet;
a housing surrounding the receptacle and having a door allowing access to the receptacle; and
a mechanism for adjusting the relative position of the receptacle and compressed gas outlet in response to movement of the door to urge the compressed gas outlet and the compressed gas inlet into sealing engagement as the door is closed.

Linking the movement of the door to the sealing engagement of the gas outlet and the inlet on the receptacle dispenses with the requirement for a user to manually seal the two together and so allows for devices that are more convenient to use, especially where users need not be trained to make a manual seal. Also, linking the sealing to the movement of the door provides an extra safety feature without the need for complex pressure-relief valves: With the door in an open position, the receptacle is not under pressure even if the gas source is still active. As an extra safety feature it is preferred that the device comprises a control system configured to restrict or prevent activation of the gas source when the door is not closed.

The features of the present device are especially advantageous when high pressure (for example at least 0.5 bar, more preferably between 1 and 5 bar) is required to dispense the food composition. Such high pressures are generally required where the food composition is highly viscous or pasty. Preferably, the food composition is a frozen confection.

The present invention is applicable to a range of frozen confections. Frozen confection means a confection made by freezing a mix (preferably a pasteurized mix) of ingredients such as water, fat, sweetener, protein (normally milk proteins), and optionally other ingredients such as emulsifiers, stabilisers, colours and flavours. Frozen confection materials may be aerated. Frozen confection materials include ice cream, gelato, frozen yoghurt, sorbets, granitas, shaved ices and the like. Preferably the frozen confection is ice cream.

The frozen confection may be aerated. The term “aerated” means that gas has been intentionally incorporated into the product, such as by mechanical means. The gas can be any food-grade gas such as air, nitrogen or carbon dioxide. The extent of aeration is typically defined in terms of “overrun” (OR). In the context of the present invention, % overrun is defined in volume terms (measured at atmospheric pressure) as:

$$O R = \frac{\begin{matrix}volume of frozen aerated product - \\ volume of premix at ambient temp\end{matrix}}{volume of premix at ambient temp} \times 100$$

The amount of overrun present in the aerated frozen confection will vary depending on the desired product characteristics. In the context of the present invention the level of overrun is typically from 0 to 150%, more preferably from 60 to 150%, most preferably from 60 to 100%.

In one embodiment the mechanism converts arcuate movement of the door into linear translation of the outlet, the inlet or both, most preferably the outlet or both. Thus as the door is swung closed its movement is transmitted (through, for example, a cam mechanism and/or one or more transmission members) to bring the outlet and inlet together. Preferably the transmission member(s) comprise one or more transmission rods.

The use of gas pressure to dispense food compositions is most effectively and hygienically achieved if the gas pressure does not act directly on the food composition but rather through a moveable wall (such as piston, bag or membrane). Thus, it is preferred that the receptacle comprises a product compartment containing the food composition and a moveable wall through which a dispensing force can be transmitted to the food product from the compressed gas. Examples of such receptacles include bag-in-bottles (where the bag acts as the moveable wall) and cartridges containing pistons (where the piston acts as the moveable wall) although other configurations are possible including, for example, containers with an end wall that is deformable to become the moveable wall (as described, for example in U.S. Pat. No. 5,893,485). Examples of bag-in-bottle type receptacles are described in WO 2007/039158 A and examples of piston-in-cartridge type receptacles are described in EP 1 449 441 A both of which documents are hereby incorporated by reference in their entirety.

The utility of the present invention is especially enhanced where the receptacle is replaceable. Therefore it is preferred that the receptacle is disposable or recyclable.

In one embodiment the receptacle preferably contains multiple portions of food composition, more preferably the receptacle contains at least 200 g of food composition, even more preferably between 250 and 3000 g, more preferably still between 300 and 2000 g and most preferably between 400 and 1000 g. In this embodiment the receptacle is preferably a bag-in-bottle type container.

In another embodiment the receptacle is for a single-serving of food composition. More preferably the receptacle comprises no more than 200 g of food composition, more preferably from 25 to 100 g of food composition.

In a second aspect, the present invention provides a system comprising the device of any embodiment of the first aspect and one or more of the receptacles.

In a third aspect, the present invention provides a method for dispensing a food composition from a receptacle comprising the steps of:
locating the receptacle inside the housing of a device of any embodiment of the first aspect;
closing the door of the device thereby urging the compressed gas outlet and the compressed gas inlet into sealing engagement; and
activating the compressed gas source to feed compressed gas through the conduit, outlet and inlet to act on the food composition within the receptacle.

It is preferred that the receptacle is removable such that the method comprises the additional steps of:
deactivating the compressed gas source;
opening the door thereby separating the compressed gas outlet and the compressed gas inlet out of sealing engagement; and
removing the receptacle from the housing.

Where the receptacle is single use (e.g. containing a single portion of food composition) a replacement receptacle will need to be installed in the device to dispense further portions. Where the receptacle contains multiple portions, it may be desirable to reinstall the same receptacle later to dispense remaining portions from the receptacle. Thus, the method preferably comprises the additional steps of:
relocating the receptacle or locating a replacement receptacle inside the housing of the device;
closing the door of the device thereby urging the compressed gas outlet and the compressed gas inlet into sealing engagement; and
activating the compressed gas source to feed compressed gas through the conduit, outlet and inlet to act on the food composition within the receptacle or replacement receptacle.

Where the food composition is a frozen composition and the receptacle contains multiple portions, the receptacle will typically be stored in a freezer between dispensing occasions as this removes or at least reduces the need for the device to have its own refrigeration means and/or for the housing to be insulated. Thus in a preferred embodiment of the method, the receptacle is relocated and between removal and relocation in the housing, the receptacle is stored at a temperature of less than −7° C., preferably less than −12° C., most preferably at a temperature of from −15 to −25° C. For example, the receptacle is stored in a freezer, preferably a domestic freezer.

### DETAILED DESCRIPTION OF PREFERRED EMBODIMENTS

The present invention will now be described, by way of example only, with reference to the figures, wherein:

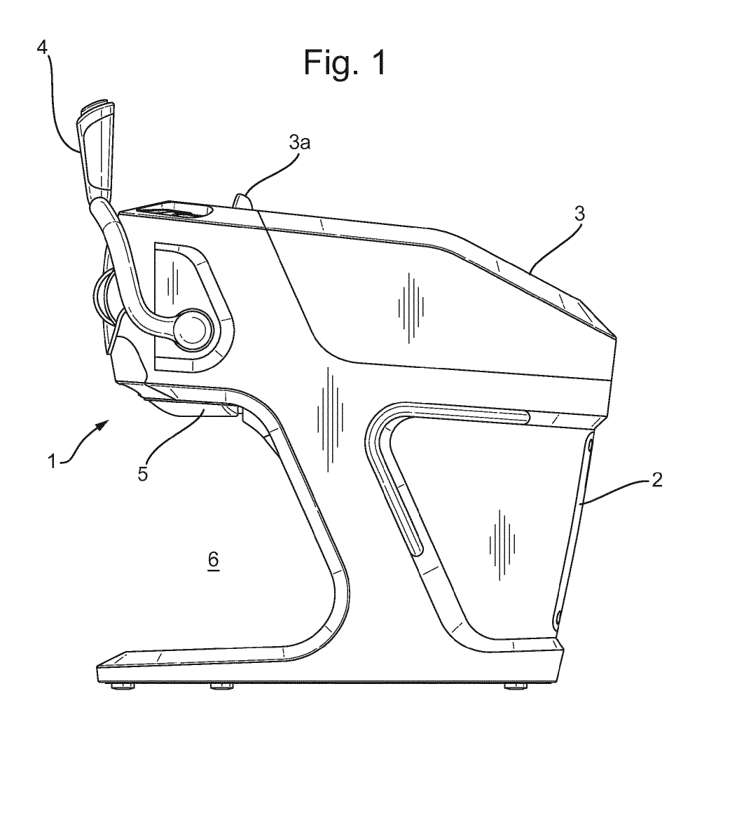

FIG. 1 shows a side view of the outside of a device according to an embodiment of the invention and which dispenses frozen confection from bag-in-bottle type receptacles.

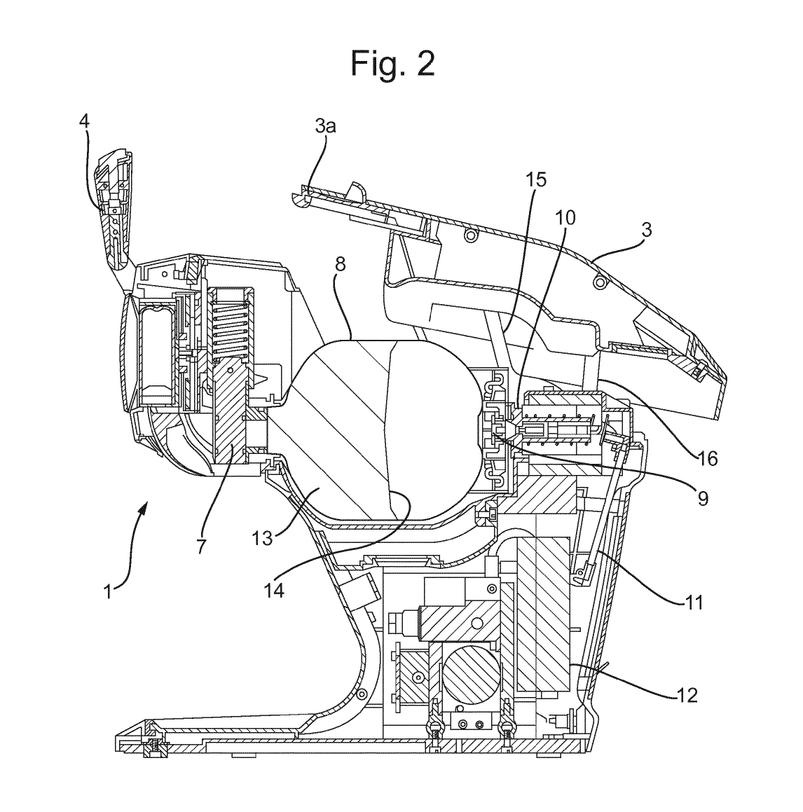

FIG. 2 shows a sectional view of the device of FIG. 1 with its door open and a receptacle in place for dispensing.

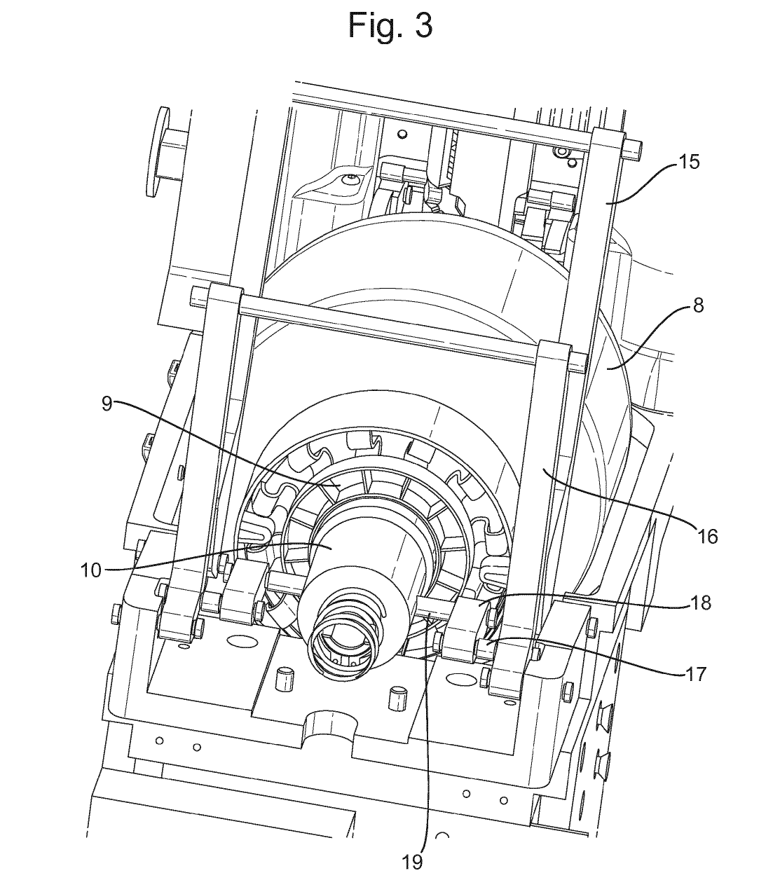

FIG. 3 shows a detailed perspective back view of part of the inside of the device of FIG. 1.

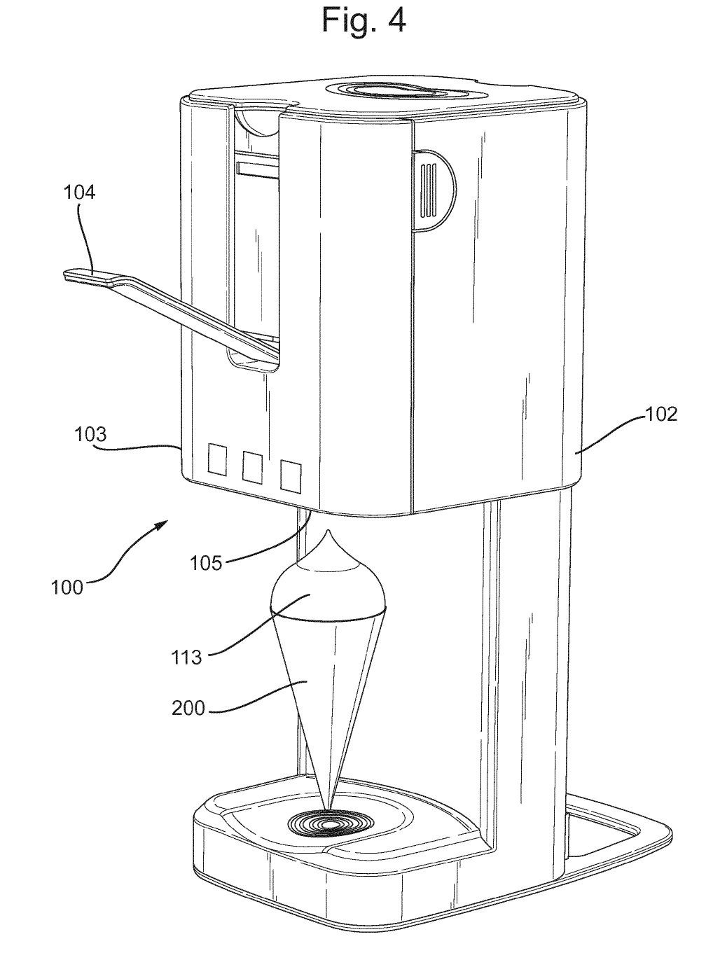

FIG. 4 shows a perspective view of the outside of a device according to another embodiment of the invention and which dispenses frozen confection from piston-cartridge type receptacles.

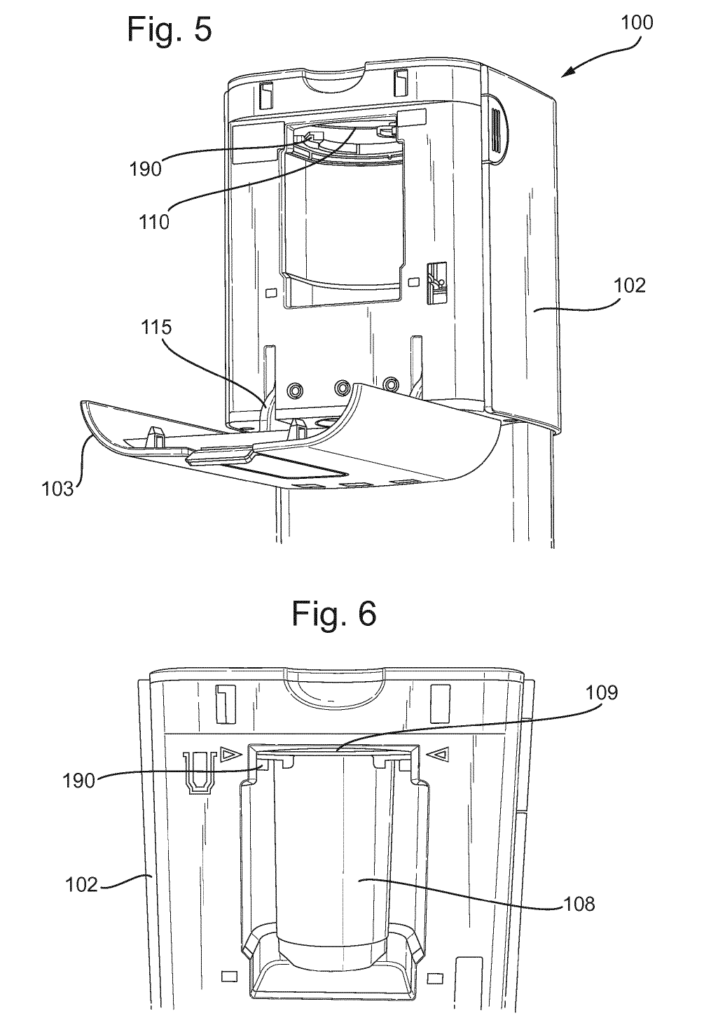

FIG. 5 shows detail of part of the device of FIG. 4 with the front door open.

FIG. 6 shows further detail of the part of the device of FIG. 5 but with a cartridge installed in the device.

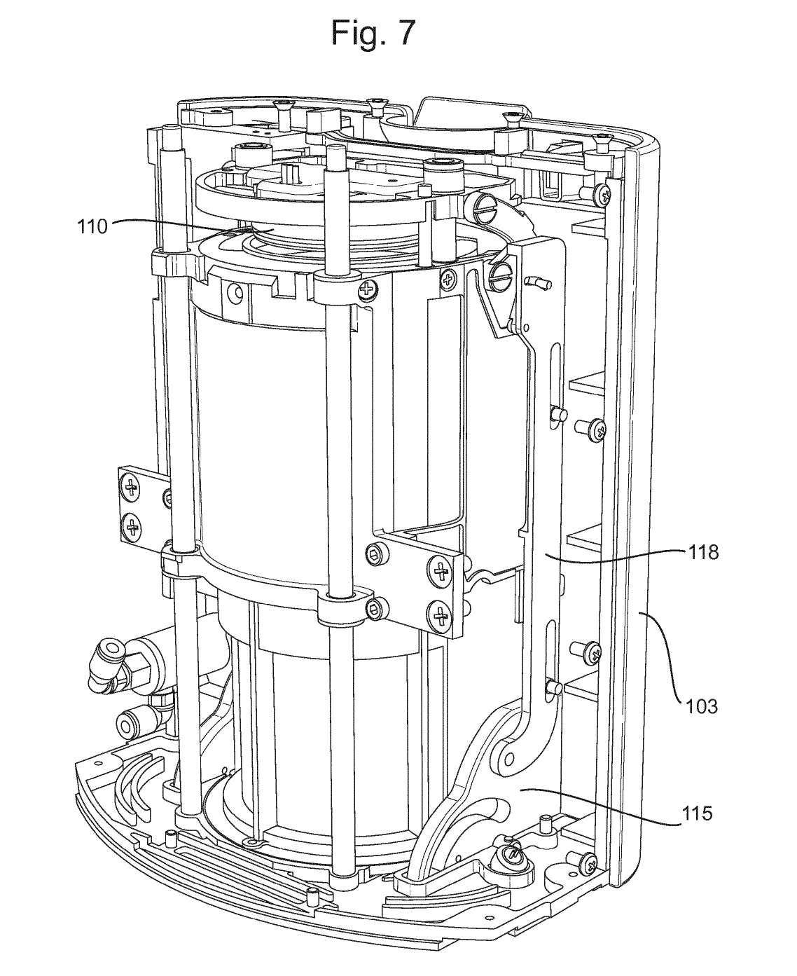

FIG. 7 shows a detailed perspective back view of the inside of the device of FIG. 4.

The embodiment of the device shown in FIGS. 1 to 3 is suitable for dispensing frozen confections from bag-in-bottle type receptacles. The device (1) comprises a housing (2) and an upper door (3) which together enclose the receptacle (8). The door (3) is connected to the housing (2) through two pairs of leg struts (15,16) to provide a 4 point bar linkage mechanism about which the door can be moved in and out of closure with the housing (2).

The bag (14) inside the bottle of the receptacle (8) forms a compartment containing the frozen confection (13). The compartment containing the frozen confection (13) is open at a dispensing end which is also the neck of the bottle of the receptacle (8) and which receives the inlet of a dispensing valve (7). The bottle of the receptacle (8) also comprises an inlet (9) through which compressed gas can be introduced through an orifice thereof to a region inside of the bottle of the receptacle (8) but outside of the bag (14).

As best seen in FIG. 2, the device (1) comprises a gas outlet (10) which with the door (3) in an open position is aligned with but spaced away from the inlet (9) of the receptacle (8). The gas outlet (10) is connected to an air pump (12) through an air line (11), forming in this embodiment the compressed gas source and conduit respectively.

As best seen in FIG. 3, the gas outlet (10) is connected through transmission rods (18) and link pins (17, 19) to one of the pairs (16) of leg struts which link the housing (2) to the door (3).

In use a receptacle (8) filled with ice cream or another frozen confection (13) is taken from a storage freezer and installed in the device as shown in FIG. 2. The door (3) is then swung closed about the 4 bar linkage formed by the struts (15, 16). As the rear struts (16) pivot forward, they move the transmission rods (18) with them which causes the gas outlet (10) to slide towards the gas inlet (9) of the receptacle (8). As the door (3) reaches its closed position (as shown in FIG. 1), the movement of the gas outlet (10) is completed and it encloses in an air-tight manner, the orifice of the gas inlet (9) of the receptacle. In the closed position the door locks to the housing (2) via a latch (3a).

The housing (2) also comprises a micro-switch (not shown) which is activated only when the latch (3a) of the door (3) is in the closed position. Activation of the micro-switch causes the air pump (12) to be activated and begin feeding air through the air line (11), the outlet (10) and the inlet (9) into the region of the receptacle (8) between the outer bottle and the bag. Air is pumped until the desired pressure (for example about 2 bar) is achieved).

The user then actuates the valve (7) by pulling a handle (4) to which it is connected. The frozen confection (13) is then urged through the open valve (7) by the air pressure acting on the bag (14). The dispensed ice cream flows through a dispensing opening (5) below the valve (7) to a space (6) which can accommodate a bowl, cone or other receptacle. If a large amount of ice cream is dispensed then the air pump (12) may periodically activate to keep the pressure within the receptacle (8) above a set threshold and thus prevent the flow rate of the ice cream becoming too slow.

Once the desired amount of ice cream has been dispensed, the user returns the handle (4) to its original position which in turn closes the valve (7). The user then actuates the latch (3a) which causes the pump to deactivate and pressure inside the device and receptacle to be dumped. As the door (3) is opened, the rear struts (16) pivot backwards, moving the transmission rods (18) with them which causes the gas outlet (10) to slide away from the gas inlet (9) of the receptacle (8). The user then removes the receptacle (8) from the device (1) and places it back in the storage freezer until the next dispensing occasion.

The micro-switch which is activated by the latch (3a) provides that the receptacle (8) can only be pressurized when the door (3) is closed. Furthermore if this safety feature were to fail then the feature that the gas inlet (10) is decoupled from the receptacle (8) when the door (3) is opened ensures that the user cannot handle the receptacle (8) in a pressurized state.

The embodiment of the device shown in FIGS. 4 to 7 is suitable for dispensing frozen confections from piston-in-cartridge type receptacles. The device (100) comprises a housing (102) and a front door (103) which together enclose the receptacle (108). The door (103) is connected to the housing (102) through two hinge members (115) to provide a pivot line at the bottom of the door (103) about which the door can be moved in and out of closure with the housing (102).

The receptacle (108) is a typical piston-cartridge having a cylindrical body with an open end (109) and a piston within the body below the open end (109). The area within the cartridge body (108) below the piston is a compartment filled with frozen confection (for example ice cream) and terminates with a dispensing orifice in the bottom thereof.

As best seen in FIGS. 5 and 6, the device (100) comprises a gas outlet (110) which with the door (103) in an open position sits in the top of the housing (102) in a space above the open end (109) of the cartridge (108) when installed in the device (100). The cartridge is held in place in the device (100) by a spring-loaded retaining clip (190). The gas outlet (110) is connected to an air pump (not shown) through an air line (not shown) which are also enclosed in the housing (102).

As best seen in FIG. 7, the gas outlet (110) is connected through transmission rods (118) to the hinge members (115).

In use a receptacle (108) filled with ice cream or another frozen confection is taken from a storage freezer and installed in the device as shown in FIG. 6. The door (103) is then swung closed about the hinge members (115). As the hinge members (115) pivot inward, they force the transmission rods (118) downwards which causes the gas outlet (110) to be pulled down to form a cap on the open end (109) of the receptacle (108). As the door (103) reaches its closed position (as shown in FIG. 4), the movement of the gas outlet (110) is completed and it encloses in an airtight manner, the open end (109) of the receptacle.

The user then actuates the air pump by pulling a handle (104) to which it is connected. The frozen confection is then urged through the dispensing orifice of the receptacle (108) by the air pressure introduced through the gas outlet (110) acting on the piston. The dispensed ice cream flows through a dispensing opening (105) below the receptacle (108) to a waiting cone (200) or other receptacle. The user can control the dispensing speed of the ice cream by varying the amount by which the handle (104) is actuated owing to a system which links the degree of handle movement to the amount of air delivered by the air pump.

Once the desired amount of ice cream has been dispensed, the user returns the handle (104) to its original position which in turn deactivates the air pump. As the user then opens the door (103), the hinge members (115) move outwards, which pushes the transmission rods (118) upwards, causing the gas outlet (110) to move away from the open end (109) of the cartridge (108). The user then removes the receptacle (108) from the device (100) and places it back in the storage freezer until the next dispensing occasion or sends it for recycling.

All numbers in this description indicating amounts of material, time periods, length scales, conditions of reaction, physical properties of materials and/or use may optionally be understood as modified by the word “about”.

It should be noted that in specifying any range of values, any particular upper value can be associated with any particular lower value.

For the avoidance of doubt, the word “comprising” is intended to mean “including” but not necessarily “consisting of” or “composed of”. In other words, the listed steps or options need not be exhaustive.

The disclosure of the invention as found herein is to be considered to cover all embodiments as found in the claims as being multiply dependent upon each other irrespective of the fact that claims may be found without multiple dependency or redundancy.

Where a feature is disclosed with respect to a particular aspect of the invention (for example a method of the invention), such disclosure is also to be considered to apply to any other aspect of the invention (for example a device of the invention) mutatis mutandis.

1. A device for dispensing a food composition from a receptacle comprising a compressed gas inlet, the device comprising:
a compressed gas source;
a gas conduit extending from the compressed gas source to a compressed gas outlet;
a housing surrounding the receptacle and having a door allowing access to the receptacle; and
a mechanism for adjusting the relative position of the receptacle and compressed gas outlet in response to movement of the door to urge the compressed gas outlet and the compressed gas inlet into sealing engagement as the door is closed.

2. The device as claimed in claim 1 wherein the device comprises a control system configured to restrict or prevent activation of the compressed gas source when the door is not closed.

3. The device as claimed in any one of the preceding claims wherein the mechanism converts arcuate movement of the door into linear translation of the outlet, the inlet or both.

4. The device as claimed in any one of the preceding claims wherein the mechanism comprises one or more transmission rods.

5. The device as claimed in any one of the preceding claims wherein the food composition is a frozen confection.

6. The device as claimed in any one of the preceding claims wherein the receptacle comprises a product compartment containing the food composition and a moveable wall through which a dispensing force can be transmitted to the food composition from the compressed gas.

7. The device as claimed in claim 6 wherein the receptacle is a bag-in-bottle.

8. The device as claimed in claim 6 wherein the receptacle is a cartridge containing a piston.

9. The device as claimed in any one of the preceding claims where the receptacle is disposable or recyclable.

10. A system comprising the device as claimed in any one of the preceding claims and one or more of the receptacles.

11. A method for dispensing a food composition from a receptacle comprising the steps of:
locating the receptacle inside the housing of a device as claimed in any one of claims 1 to 9;
closing the door of the device thereby urging the compressed gas outlet and the compressed gas inlet into sealing engagement; and
activating the compressed gas source to feed compressed gas through the conduit, outlet and inlet to act on the food composition within the receptacle.

12. The method as claimed in claim 11 wherein the method comprises the additional steps of:
deactivating the compressed gas source;
opening the door thereby separating the compressed gas outlet and the compressed gas inlet out of sealing engagement; and
removing the receptacle from the housing.

13. The method as claimed in claim 12 wherein the method comprises the additional steps of:
relocating the receptacle or locating a replacement receptacle inside the housing of the device;
closing the door of the device thereby urging the compressed gas outlet and the compressed gas inlet into sealing engagement; and
activating the compressed gas source to feed compressed gas through the conduit, outlet and inlet to act on the food composition within the receptacle or replacement receptacle.

14. The method as claimed in claim 13 wherein the receptacle is relocated and between removal and relocation in the housing, the receptacle is stored at a temperature of less than −7° C., preferably less than −12° C.

15. The method as claimed in any one of claims 11 to 14 wherein the receptacle contains multiple portions of food composition, preferably wherein the receptacle contains at least 200 g of food composition.
